(19) United States
(12) Patent Application Publication
(10) Pub. No.: US 2019/0163849 A1
(43) Pub. Date: May 30, 2019

(54) SYSTEM THAT CREATES A COMPLEX FLUID MECHANISM OVER A BLUNT BODY WITH AND WITHOUT A DECELERATOR AND WITH REGARD TO A TOTAL AERODYNAMIC DRAG

(71) Applicant: Khaled Abdullah Alhussan, Riyadh (SA)

(72) Inventor: Khaled Abdullah Alhussan, Riyadh (SA)

(21) Appl. No.: 16/204,124

(22) Filed: Nov. 29, 2018

Related U.S. Application Data
(60) Provisional application No. 62/592,087, filed on Nov. 29, 2017.

(51) Int. Cl. G06F 17/50; G06F 17/10

(52) U.S. Cl. CPC G06F 17/5009; F15D 1/10; G06F 17/5086; G06F 17/10

(57) ABSTRACT

A system for creating an analysis to be used in development of a design methodology for creating a blunt body with optimal performance, the system includes a first blunt body model lacking a deceleration device; a second blunt body model with a deceleration device integrated into the second blunt body model; a computational fluid dynamic module to perform data analysis on the first blunt body model and the second blunt body model; contoured plots relating to fluid flow around the first blunt body and the second blunt body as determined by the computational fluid dynamics module; the contoured plots provide a numerical analysis to be used to develop a design of the blunt body with optimal performance.

### BACKGROUND

### 1. Field of the Invention

The present invention relates generally to methods and systems for improving designs of bodies moving through a fluid medium, and more specifically, to a system that creates a computational model that illustrates complex fluid mechanism over a blunt body with and without a decelerator and with regard to a total aerodynamic drag for use in developing a design methodology so as to predict optimal performance of a blunt body.

### 2. Description of Related Art

Methods and systems for improving designs associated with bodies moving through a fluid medium are common in the art and involve the use of computational fluid dynamics (CFD). These methods and systems rely on numerical analysis and data structures to evaluate fluid flows. It is important to understand that these methods and systems provide analysis relating to the effects of aerodynamic drag on a body, the results then being used to improve designs, such as the surface structure and shape of the body.

One of the problems associated with conventional methods and systems for improving designs associated with bodies moving through a fluid medium is the inadequate evaluation of the incorporation of deceleration devices into a blunt body. The evaluation of such a design modification is important as the fluid flow structure will be subject to sever change of aerodynamic forces and velocity based on the added deceleration device.

Accordingly, although great strides have been made in the area of systems for improving blunt body designs, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified side view of a blunt body without a deceleration device and a blunt body with a deceleration device in accordance with a system that creates a complex fluid mechanism over a blunt body with and without a decelerator and with regard to a total aerodynamic drag;

FIG. 2 is a cross sectional view of the blunt body without a deceleration device of FIG. 1;

FIG. 3 is a cross sectional view of the blunt body with a deceleration device of FIG. 3;

FIG. 4 is a plot of the fluid flow associated with the blunt body without a deceleration device of FIG. 1;

FIG. 5 is a plot of the fluid flow associated with the blunt body with a deceleration device of FIG. 1;

FIG. 6 is a flowchart of the analysis of the blunt body without a deceleration device of FIG. 1; and

FIG. 7 is a flowchart of the analysis of the blunt body with a deceleration device of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional systems for improving blunt body designs. Specifically, the present invention provides a system for the analysis of complex fluid flow associated with blunt bodies with and without a deceleration device, thereby providing computational data for determining an improved design model for a blunt body. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

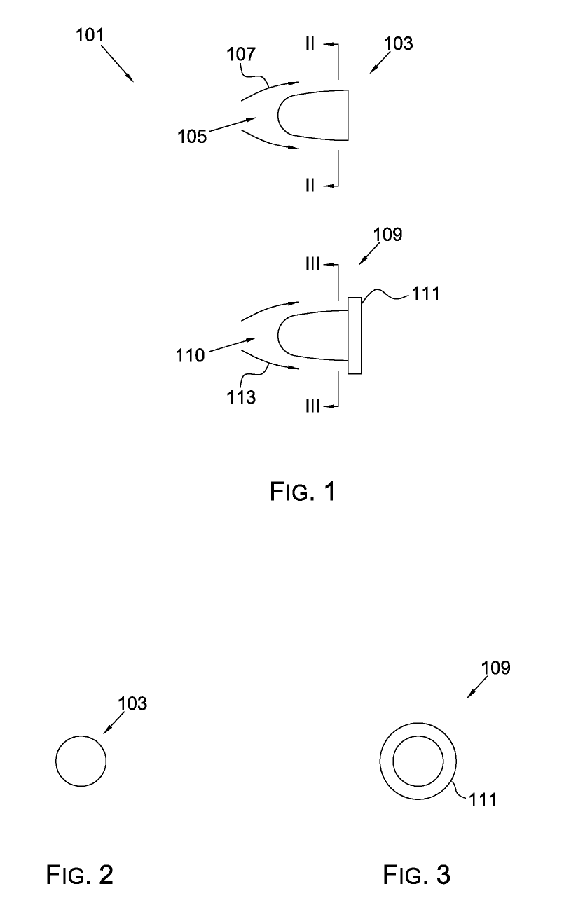

Referring now to the drawings wherein like reference characters identify corresponding or similar elements throughout the several views, FIGS. 1-4 depict various simplified views of a system 101 for creating and analyzing a complex fluid mechanism over a blunt body with and without a deceleration device with regard to a total aerodynamic drag. It will be appreciated that system 101 overcomes one or more of the above-listed problems commonly associated with systems for improving blunt body designs.

In the contemplated embodiment, system 101 includes a computational fluid dynamic (CFD) module for analysis of a model of a first body 103 having a blunt end 105 and receiving fluid flow 107 therearound, and a second body 109 with a blunt end 110 and having a decelerator device 111 integrally attached to body 109 and receiving fluid flow 113 therearound. The computational fluid dynamic analysis is used to model detached shock waves, fluid separation, and the interaction between the two, of both the first body and the second body, wherein the numerical analysis can be used to develop a design methodology so as to predict optimal performance of a blunt body with or without a deceleration device. The analysis is based on total aerodynamic drag about the blunt body as created between the blunt body and fluid flow therearound.

It should be understood that drag over a moving body consists of two components: pressure drag and friction drag. Pressure drag is the primary drag associated with the movement of a blunt body through fluid, and a result of the circular movement generated in fluid due to the movement of the blunt body. Frictional drag is related to the surface area exposed to the fluid flow 107, 113. In the present application, the first and second bodies 103, 109 are shown without and with a decelerator device 111 to demonstrate the complex fluid mechanism around a blunt body, and in connection primarily to pressure drag as is increased in the body having a deceleration device integrated therein.

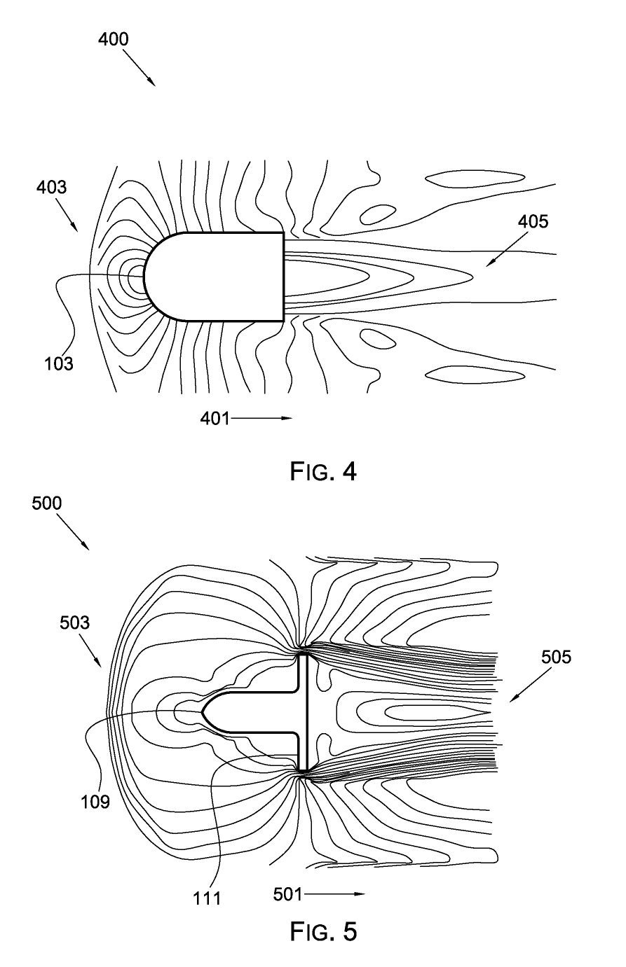

As shown in FIGS. 2 and 3, cross sectional views of body 103 and body 109 are shown. In FIG. 2, the cross sectional view is taken from line II of FIG. 1, and in FIG. 3, the cross sectional view is taken from line II of FIG. 1, wherein the overall cross-sectional area of body 103 is significantly less than the cross-sectional area of body 109 having deceleration device 111. It must be understood that when a decelerator device 111 is integrated into body 109, the fluid flow is subject to sever change of aerodynamic forces and velocity due to the increased pressure drag.

It should be appreciated that one of the unique features believed characteristic of the present application is the analysis of a complex fluid mechanism associated with fluid flow around a blunt body having a decelerator device secured thereon, when the blunt body is moving at a supersonic speed. It should be appreciated that this feature provides an analysis for a design methodology so as to predict optimal performance of a blunt body having a deceleration device secured thereon.

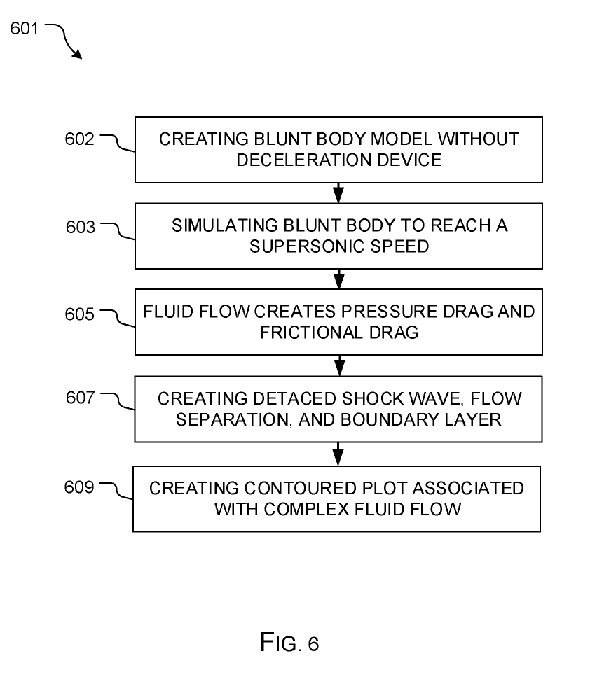

In FIG. 4, a contoured plot 400 of fluid flow 401 around body 103 is shown. In this figure, detached shock waves 403 are shown as created by the fluid flow 401. This figure further shows flow separation 405 as associated with a blunt body lacking a deceleration device. As compared to FIG. 5, wherein a contoured plot 500 demonstrates fluid flow 501 around body 109. In this plot, detached shock waves 503 and flow separation 505 are shown as created by a blunt body having a deceleration device. It should be understood that the addition of deceleration device 111 increases the flow separation behind the blunt body. It should be understood that the subject of the present application is the creation of a complex fluid mechanism over both a blunt body without a decelerator and a blunt body with a decelerator. The complex fluid mechanism provides for analysis to create a methodology to predict optimal performances of blunt bodies moving at supersonic speeds.

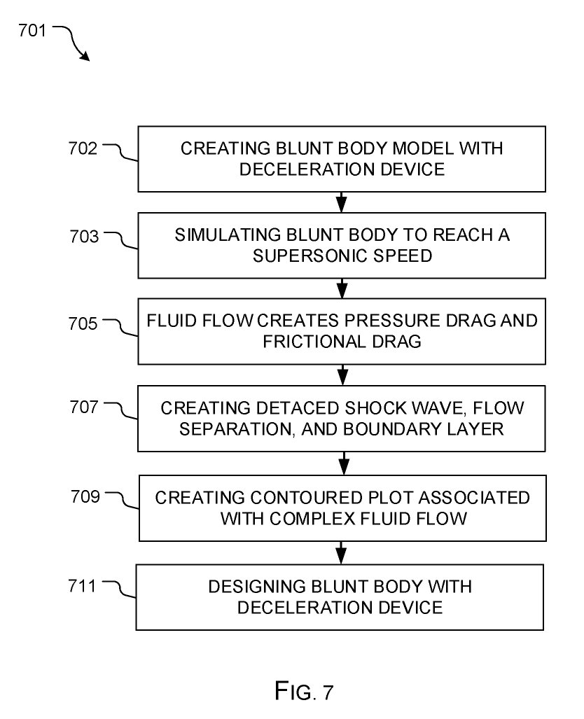

In FIG. 6, a flowchart 601 depicts the analysis associated with fluid flow about a blunt body without a deceleration device. A model of a blunt body without a deceleration device is created, as shown with box 602. The blunt body is simulated to accelerate to reach a supersonic speed, wherein fluid flow around the body creates both pressure drag and frictional drag, as shown with boxes 603, 605. The fluid flow about the body creates a detached shock wave, flow separation, and a boundary layer, as shown with box 607. A computational plot associated with the complex fluid flow is created, wherein the plot is used with analysis to determine a design of blunt body relating to optimal performance, as shown with box 609.

In FIG. 7, a flowchart 701 depicts the analysis associated with fluid flow about a blunt body having a deceleration device secured thereon. A model of a blunt body with a deceleration device is created, as shown with box 702. The blunt body is simulated to accelerate to reach a supersonic speed, wherein fluid flow around the body creates both pressure drag and frictional drag, as shown with boxes 703, 705. The fluid flow about the body creates a detached shock wave, flow separation, and a boundary layer, as shown with box 707. A contoured computational plot associated with the complex fluid flow is created, wherein the plot is used for analysis to determine the effects of the incorporated deceleration device, as shown with box 709. Designing the shape and size of the deceleration device as desired for optimal performance of the blunt body, as shown with box 711.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system for creating an analysis to be used in development of a design methodology for creating a blunt body with optimal performance, the system comprising:
a first blunt body model lacking a deceleration device;
a second blunt body model with a deceleration device integrated into the second blunt body model;
a computational fluid dynamic module configured to perform data analysis on the first blunt body model and the second blunt body model;
a plurality of contoured plots relating to fluid flow around the first blunt body and the second blunt body as determined by the computational fluid dynamics module;
wherein the plurality of contoured plots provide a numerical analysis to be used to develop a design of the blunt body with optimal performance.

2. The system of claim 1, wherein the deceleration device is integrated into an end opposite of a blunt end of the second blunt body module.

3. The system of claim 1, wherein the plurality of contoured plots comprises:
a visual representation of detached shock waves associated with the first blunt body model movement through fluid and the second blunt body movement through fluid; and
a visual representation of flow separation associated with the first blunt body model movement through fluid and the second blunt body movement through fluid.

4. A method for creating a blunt body with optimized performance, the method comprising:
creating a first blunt body model without a deceleration device;
creating a second blunt body model with a deceleration device integrated into the second blunt body model;
implementing analysis on the first blunt body model and the second blunt body model through use of a computational fluid dynamics module, wherein the analysis is based on fluid flow;
developing a first contoured plot associated with fluid flow around the first blunt body model;
developing a second contoured plot associated with fluid flow around the second blunt body model; and
analyzing the first contoured plot and the second contoured plot to determine effects associated with an inclusion of the deceleration device into the second blunt body.

5. The method of claim 4, wherein the first contoured plot and second contoured plots each comprise:
a visual representation of detached shock waves; and
a visual representation of flow separation.
